(19) United States
(12) Patent Application Publication
(10) Pub. No.: US 2008/0132626 A1
(43) Pub. Date: Jun. 5, 2008

(54) Sprayable thixotropic polymer decorative coating material

(76) Inventors: Stuart B. Smith, Loganville, GA (US); Justin Beard, Knoxville, TN (US)

Correspondence Address: PATTON BOGGS, LLP, 2001 ROSS AVENUE, SUITE 3000, DALLAS, TX, 75201, US

(21) Appl. No.: 11/607,394

(22) Filed: Dec. 1, 2006

(51) Int. Cl. B32B 27/20; B05D 1/02

(52) U.S. Cl. 524/300; 427/427.4

(57) ABSTRACT

The present sprayable decorative coating material is composed of acrylic chips or gel coat chips that are mixed with polyurea and acrylic aqueous resins with special thixotropic material to produce a sprayable decorative coating for a solid surface. The present sprayable decorative coating material may be mixed with acrylic chips or gel coat chips. Different colored chips or mixtures of chips may be used to produce a wide array of finished decorative coating materials. The specific gravity of the resin of the chips is similar to the resin of the present sprayable decorative coating material, thus they are effectively suspended during mixing, spraying, and hardening, and may be applied to horizontal or vertical surfaces. The present sprayable decorative coating material uses a thixotropic compound that enables the resin mixture to be thin on shear when sprayed out of a low-pressure hopper gun, and the like.

### FIELD OF THE INVENTION

The field of the invention is directed to sprayable polymer coatings, more particularly to a sprayable thixotropic polymer decorative coating material.

### BACKGROUND OF THE INVENTION

Solid surface materials, such as Corian®, and the like, are typically thermosetting plastics or solid resin materials that are widely used primarily as countertops in home and commercial applications. Some desired characteristics of these types of materials include that they are generally damage and stain resistant, resemble a high-end solid surface material, such as granite, and are moldable. A typical composition for these types of materials includes mixing an acrylic based thermoplastic monomer with a peroxide to produce a moldable polymer resin.

The resulting resin or unprocessed plastic typically is in the form of small beads or pellets that are then cast, extruded, or injected into a mold to produce a final product in sheet form. Additionally, colorants and additives, such as acrylic chips or gel coat chips, may be added for enhanced aesthetics. For example, fillers may be used in ratios such as 60% filler to 40% resin; however, these common ratios significantly increase the viscosity of the composition such that it can only be cast, extruded, or molded. The processes for making the sheet product must be tightly controlled in order to produce such sheets, thus this is why only large plastic processors produce such products. For example, if too much heat is used during manufacture, then air pockets may be created that may produce undesirable effects, such as a poor color finish. Further, they can not be produced on the job site directly from the reactant chemicals.

The sheets are then transported to a job site where they are cut into desired shapes for use as countertops and the like. Installers must use tools to cut the sheets to size and then use special seam adhesive to seal the seams between two adjacent pieces. In addition, the seams must be smoothed with an abrasive scrubber to produce a uniform appearance across a joined section of sheets. Furthermore, due to the density of these materials and the size and thicknesses of the sheets, the sheets are heavy and unwieldy to handle, thus requiring a substantial amount of labor to transport and install at a job site.

In addition to these solid surface materials, others have attempted to use spraying processes to produce solid surface materials. For example, water-based polyurethanes have been tried but they can not be used underwater without blushing and have relatively poor adhesion. Water based polycarbonates have been tried, and although they do possess some good properties, but they are slow drying and typically require heat to cure. Both of these polyurethane resins contain coalescent agents such a N-Methyl pyrolidione. Colored quartz may be mixed with solvent or aqueous acrylics and then sprayed on a solid substrate; however, the finish of these attempts does not provide that of natural stone. In addition, due to its high specific gravity, colored quartz causes processing problems when it is mixed with solvent-based acrylics. The round quartz granules do not pack well and leaves many voids in the acrylic. Plus, when it is sprayed on a vertical surface, the colored quartz granules tend to bounce back due to its weight. Further, acrylic resins used these spraying process are slow drying, sometimes taking up to 24 hours to dry, and are very sensitive to “blushing” or tuning white when wet. Also, storage of these mixtures are difficult as well because of the weight of the quartz. For example, a typical spray ratio is 50 pounds of quartz to approximately 1.25 gallons of acrylic resin.

### SUMMARY

The present sprayable thixotropic polymer decorative coating material (“sprayable decorative coating material”) is composed of acrylic chips or gel coat chips that are mixed with polyurea and aqueous acrylic resins with a special thixotropic material to produce a sprayable decorative coating for a solid substrate, such as concrete, concrete floors, concrete patios, sidewalks, driveways, walls, tile, metal, wood, masonite siding, gypsum, floors, interior/exterior walls, patios, sidewalks, interior floors, pool decks, and many other substrates. The present sprayable decorative coating material may be mixed with acrylic chips or gel coat chips and sprayed onto a supporting substrate, such as those described herein. Different colored chips or mixtures of chips maybe used to produce a wide array of finished decorative coating materials. The specific gravity of the resin of the chips is similar to the resin of the present sprayable decorative coating material, thus they are effectively suspended during mixing, spraying, and hardening, and may be applied to horizontal or vertical surfaces without experiencing the negative effects of previous methods and compositions. The present sprayable decorative coating material uses a thixotropic compound that enables the resin mixture to be thin on shear when sprayed out of a low-pressure hopper gun, and the like.

The present sprayable decorative coating material further includes a method for spraying a thixotropic polymer decorative coating material onto a substrate. This method can be sprayed with common low-pressure spraying equipment, but that don't work with existing conventional materials and processes. The present sprayable decorative coating material doesn't blush, sets up well, tacks well, and has great properties. Furthermore, the present sprayable decorative coating material is non-flammable, odorless, and can be washed clean from tools and hands with water. In addition, the present sprayable decorative coating material can be a top coat or a sealer.

### BRIEF DESCRIPTION OF THE DRAWINGS

FIG. 1 illustrates an exemplary hopper gun system for spraying a decorative coating material onto a substrate according to an embodiment of the present invention;

FIG. 2 illustrates an exemplary texture spraying system for spraying a decorative coating material onto a substrate according to another embodiment of the present invention; and

FIG. 3 illustrates a block diagram of an exemplary process for spraying a decorative coating material according to an embodiment of the present invention.

### DETAILED DESCRIPTION OF THE DRAWINGS

The present sprayable decorative coating material is comprised of an aqueous polyurea, polyurethane, polycarbonate, and self-crossing acrylics that includes fillers that are then sprayed onto a substrate, such as concrete, concrete floors, concrete patios, sidewalks, driveways, walls, tile, metal, wood, masonite siding, gypsum, floors, interior/exterior walls, patios, sidewalks, interior floors, pool decks, and many other substrates. The resins selected are breathable coatings which are very important when sprayed on surfaces which could outgas and build pressure. Substrates that outgas or build pressure are generally indoor concrete slabs that are climate controlled using HVAC systems. Many concrete surfaces have pressure under the surface, a breathable coating allows the gas to escape. The present sprayable decorative coating material includes acrylic chips or gel coat chips mixed with polyureas, polyurethanes, acrylics, or polycarbonate resins and then sprayed on a substrate or surface to produce a decorative surface.

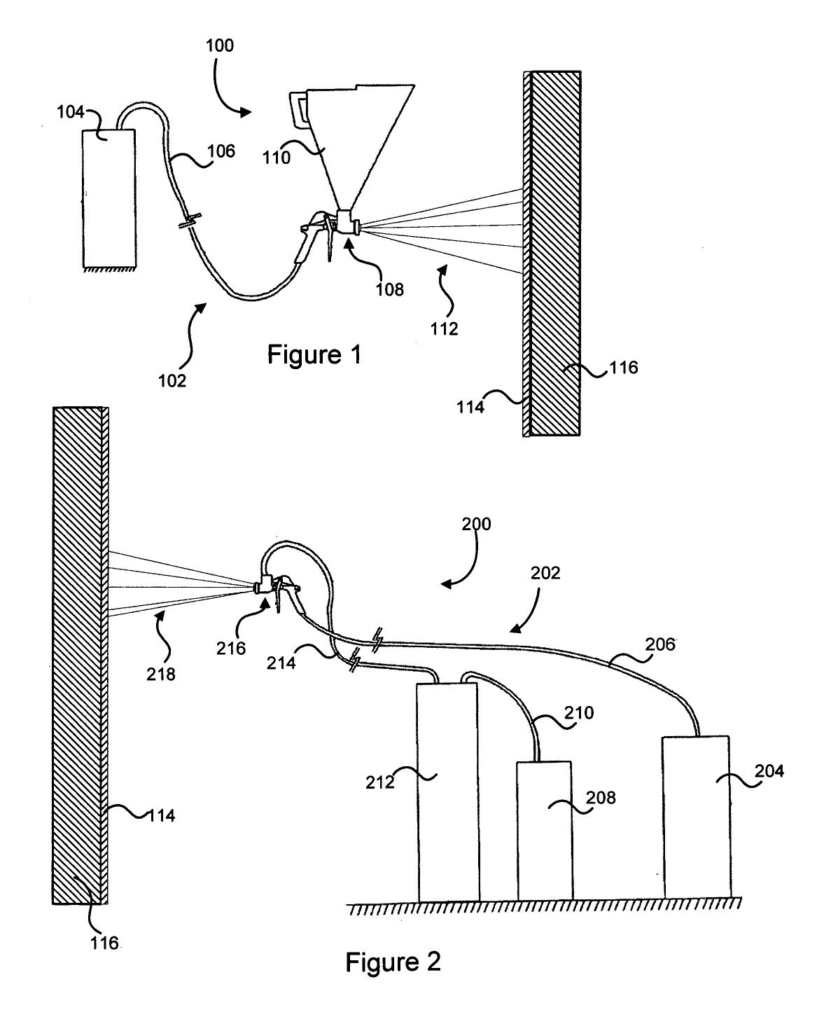

Referring to FIGS. 1 and 2, two embodiments of the present sprayable decorative coating material are shown. FIG. 1 illustrates an embodiment 100 of a system for spraying a thixotropic resin mixture 112 onto a substrate 116 that dries to a decorative coating material 114 on the substrate 116. The system 100 includes a low pressure spraying machine 102 that comprises a supply of pressurized gas 104, such as air, that is connected to a supply line 106 that feeds the pressurized gas to a spraying gun 108. The supply of pressurized gas 104 may be provided by a compressor that is commonly known and used in the texture application industry. The low pressure spraying machine 102 is commonly used in the construction trade for spraying textured ceilings and walls. The spraying gun 108 includes a hopper 110 that contains the thixotropic resin mixture 112. The low pressure spraying machine 102 is preferably a low pressure texture spraying device or machine. The spraying gun 108 may use different sized nozzles to achieve the desired application rate. An exemplary low pressure spraying machine 102 is a Spraying Mantis Hopper Gun that is manufactured by Wal-Board Inc.

FIG. 2 illustrates an embodiment 200 of a system for spraying a thixotropic resin mixture 218 onto a substrate 116 that dries to a decorative coating material 114 on the substrate 116. The system 200 includes a high volume low pressure (HVLP) spraying machine 202 that comprises a supply of pressurized gas 204 and 208, such as air, that is connected to a supply line 206 and 210, respectively. Supply line 206 provides the pressurized gas to a spraying gun 216 that sprays the thixotropic resin mixture 218 onto the substrate 116. Supply line 210 provides the pressurized gas to a container or hopper 212 that contains the thixotropic resin mixture 218 for pressurizing the thixotropic resin mixture 218 to the spraying gun 216. The supply of pressurized gas 204 and 208 may be provided by a compressor that is commonly known and used in the texture application industry. The HVLP spraying machine 202 is also commonly used in the construction trade for spraying textured ceilings and walls. The spraying gun 216 may use different sized nozzles to achieve the desired application rate. Additionally, the spraying machine 202 is preferably a low pressure system that requires a sufficient supply of pressurized gas, such as approximately 100 pounds per square inch (psi), to the spraying gun 216 in order to supply the volume of gas or air needed to spray the product at approximately 20-50 psi.

The thixotropic resin mixture 112 and 218 are preferably a single component that has a long working time; however, it may be preferable to keep the hopper 110 and 212 covered so that the thixotropic resin mixture 112 and 218 from drying on the top surface. An exemplary low pressure spraying machine 202 is the RIX 1500 manufactured by Graco®. It is a professional HVLP texture sprayer that has capacity (15 gal.) that is designed to spray large volumes of aggregated materials per hour. Typically, the substrates 116 may need to be prepared prior to being sprayed with the thixotropic resin mixture 112 and 218. For example, in one aspect, substrates 116 are prepared using 4000 psi heated pressure washers, shotblast machines, or diamond grinders to provide a preferable minimal profile of approximately 0.005″-0.010″.

In one embodiment, a thixotropic resin mixture that contains castor oil and polycarbonate seem to give very good water resistance, dry fast, and has good properties. A polycarbonate resin which has castor oil included in the backbone typically performs better. The polycarbonate gives excellent chemical resistance and has a carboxylate group which can be crosslinked with carbodiimide to improve adhesion, chemical resistance, and drying. Preferably, the solids content for the resins are in the range of about 40-45%. Self-crosslinking aqueous acrylic resins may also be used in the present decorative coating material. Mixtures of these self-crosslinking acrylics were mixed with a polycarbonate castor oil material and found to be very compatible, actually complimentary with each other that each resin alone did not have, thus providing additional adhesion of the present decorative coating material to a substrate.

In another embodiment, the thixotropic resin mixture may comprise an aqueous polyurea. Generally, a polyurea means an elastomer created by the chemical reaction between an isocyanate and an amine. It can be a monomer, polymer, or any variant reaction of isocyanates, quasi-prepolymer, or prepolymer. Further, the aqueous polyurea may be an aqueous polyurea dispersion.

In yet another embodiment, the thixotropic resin mixture may comprise an aqueous polycarbonate. In still yet another embodiment, the thixotropic resin mixture may comprise an aqueous polyurethane. Another embodiment provides for the thixotropic resin mixture to comprise an aqueous polyurethane/polyurea dispersion mixture. In addition, the present sprayable decorative coating material may also be mixed with self-crosslinking aqueous acrylic resins for added adhesion characteristics of the material.

Further, the present sprayable decorative coating material may also be crosslinked with a carbodiimide resin. The carboxyl group on the polymers can react with isocyanate, aziridiene, or silanes. Further, the sprayable decorative coating material may also be crosslinked with an acrylic. This self-crosslinking acrylic improves the adhesion of the sprayable decorative coating material.

The thixotropes that are added to the resin mix to make the present sprayable decorative coating material further enable it to be sprayed on a substrate, either horizontal or vertical, without running on the substrate. Preferably, thixotropic materials are used to suspend the acrylic chips or gel coat chips. The present sprayable decorative coating material thins out on shear, such as when spraying, and then thickens again when applied on a vertical wall. In addition, wetting agents may be used to wet the substrate and adhere and also wet the chips. For example, a pressure sensitive adhesive, such as a silicone that is water soluble may be used that does not affect recoat ability. An exemplary silicone wetting agent includes CoatoSil® 1211 manufactured by OSi Specialities. In another aspect, the thickeners may be Newtonian characteristic thickeners as well. An exemplary Newtonian thickener is Byk-420 manufactured by Byk-Chemie. Typically, these thickeners have a viscosity that is constant and not shear-rate dependent. The thixotropic material is used to enable the resin that when the resin composition was sheared, such as when being sprayed onto a substrate, it would have a liquid consistency, but that the resin would thicken quickly upon being deposited or sprayed on a substrate. The present decorative coating material provides for compositions that keep all of the components in suspension. Preferably, the thickener may be sheared into the resin prior to adding the chips. In one aspect, the texture of the mixture has a course consistency. In another aspect of the present sprayable decorative coating material maybe mixed with a aqueous silicone for additional wetting.

The fillers used in the present sprayable decorative coating material maybe ground up acrylic chips, such as from DuPont®, or ground up gel coat chips. Other chips are contemplated as well depending on the application and desired finish of the decorative coating material. Preferably, the irregular shapes of these chips pack and densify to produce a desirable appearance to the present sprayable decorative coating material. Particle size of the chips as well as application techniques determine if the coating will have a rough or smooth surface. The irregular shapes of these chips pack when sprayed, leaving very little voids. Neat resins can be sprayed, squeegee or rolled over the sprayer material to minimize voids and to change gloss. The resin mixture that binds these chips preferably dies fast and has excellent wetting ability. In one embodiment, the chips are in the range of about 20-40 mesh.

In one embodiment, a base color, such as grey, is sprayed and dried on a substrate. Base color is generally defined as the first color sprayed on a substrate, such as concrete, in a multi-colored application in order to yield a faux look or a grout line. Fiber reinforced trim tapes are then used to place over the base color in a design and a second color is the sprayed and dried to create decorative designs. The trim tape is a special tape that is either fiber or wire reinforced to enable the tape removal after the final color has been applied and allowed to dry. Failure to use this special tape will generally result in the tape that was used being permanently adhered to the substrate without the possibility of removal. Then the tape is removed to produce a decorative coating that has a very rich multi-colored textual look.

In another embodiment, a clear coat material may be applied to the present sprayable decorative coating material to seal it. For surfaces where heavy industrial traffic is required, a two-component polyurea coating may be applied over the sprayed chips to make a solid monolithic surface without any porosity. Preferably, all of these resins are aliphatic compounds so that the sprayed systems are UV stable and will not change color in the sunlight. Two-component polyurea coatings or two-component epoxy resins can be applied over the surface to produce a high gloss protective coating which do not breath. In another aspect, a breathable coating, such as a neat resin, may be applied over the sprayable decorative coating material. The neat resin can be applied to wood, concrete, or tile as a breathable UV stable protective coating. Generally, the term neat resin means it has no pigment. A breathable material means one that allows water vapor to pass through it but not water molecules.

Further, colored pigments may be added to the neat resin to produce a desired color of finish. For example, the pigments may be an organic or inorganic pigment. They may also be a transparent iron oxide stains for wood and concrete. Additionally, the neat resin may be made fire-retardant by using aluminum trihydrate in the composition.

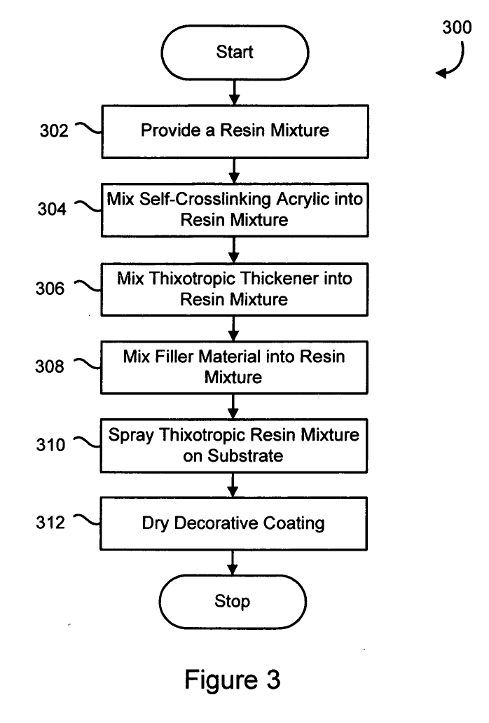

In addition to the aforementioned aspects and embodiments of the sprayable decorative coating material, the present invention further includes methods for spraying a decorative coating material on a substrate, such as concrete, concrete floors, concrete patios, sidewalks, driveways, walls, tile, metal, wood, masonite siding, gypsum, floors, interior/exterior walls, patios, sidewalks, interior floors, pool decks, and many other substrates. FIG. 3 illustrates a block diagram of an embodiment 300 of an exemplary process for spraying a decorative coating material on a substrate according to an embodiment of the present invention. In step 302, a resin mixture is provided. In step 304, a self-crosslinking acrylic is mixed in the resin mixture. In step 306, a thixotropic material is mixed in with the resin mixture with high shear to produce a thixotropic resin mixture. Once the thixotropic resin mixture has thickened up, then the fillers or chip material are added in step 308. In step 310, the thixotropic resin mixture is sprayed on the substrate to produce a thixotropic polymer decorative coating on the substrate. In step 312, the decorative coating is dried.

A non-limiting example of the novel sprayable decorative coating material is provided below.

### EXAMPLE 1

### Resin and Acrylic Mix

20 pounds of acrylic chips are mixed with approximately 9 quarts of a mixture of polycarbonate-castor oil and a self-crosslinking acrylic resin, such as NexAmine H 5000 from Reactamine Technology™, until it has a coarse consistency, such as that resembling pancake batter. Then it is loaded into a RTX 1500 machine produced by Graco® or a Spraying Mantis manual Hopper and sprayed onto a solid substrate. The material is spray applied on a prepared concrete floor at room temperature at a thickness of approximately 0.040″ and then allowed to dry for about 15 minutes.

The present sprayable decorative coating material can be sprayed on horizontal or vertical surfaces. The sprayable decorative coating material has a consistency that enables it to be loaded into a low-pressure hopper gun or ceiling texture gun, such as those used to spray textured coatings on walls and ceilings. An exemplary RTX 1500 machine produced by Graco. The sprayable decorative coating material is sprayed and deposited on the substrate to any desired thickness. The sprayable decorative coating material may be sprayed to a thickness of between 0.002″ to 0.080″ thick In one embodiment, the thickness is 0.040″ thick

There has been described a novel sprayable decorative coating material. It should be understood that the particular embodiments described within this specification are for purposes of example and should not be construed to limit the invention. Further, it is evident that those skilled in the art may now make numerous uses and modifications of the specific embodiment described, without departing from the inventive concepts. For example, other self-crosslinking acrylics can be used. In addition, other spraying machines other than those described herein can be used to spray the thixotropic resin mixture. It is also evident that the process steps recited may in some instances be performed in a different order, or equivalent structures and processes may be substituted for the various structures and processes described. The structures and processes may be combined with a wide variety of other structures and processes.

What is claimed:

1. A method for spraying a decorative coating material on a substrate comprising:
providing a resin mixture selected from the group consisting of polyureas, and polyurethanes, polycarbonates;
mixing a self-crosslinking acrylic into said resin mixture;
mixing a thixotropic thickener into said resin mixture to produce a thixotropic resin mixture;
mixing a chip material into said resin mixture; and
spraying said thixotropic resin mixture onto said substrate to produce said decorative coating material.

2. The method for spraying a decorative coating material on a substrate of claim 1 wherein said spraying comprises:
spraying said resin mixture with a texture sprayer.

3. The method for spraying a decorative coating material on a substrate of claim 1 wherein said chip material is selected from the group consisting of acrylic chips and gel coat chips.

4. The method for spraying a decorative coating material on a substrate of claim 1 wherein said thixotropic thickener is a material having Newtonian characteristics.

5. The method for spraying a decorative coating material on a substrate of claim 1 further comprises:
mixing a wetting agent into said resin mixture.

6. The method for spraying a decorative coating material on a substrate of claim 1 further comprising:
crosslinking said thixotropic resin mixture with a carbodiimide.

7. The method for spraying a decorative coating material on a substrate of claim 1 further comprising:
mixing a aqueous silicone to said thixotropic resin mixture.

8. The method for spraying a decorative coating material on a substrate of claim 1 further comprising:
sealing said decorative coating material with a breathable sealant selected from the group consisting of two-component polyurea and two-component epoxy resin.

9. The method for spraying a decorative coating material on a substrate of claim 1 further comprising:
sealing said decorative coating material with a neat resin.

10. The method for spraying a decorative coating material on a substrate of claim 1 further comprising:
adding a colored pigment to said thixotropic resin mixture.

11. The method for spraying a decorative coating material on a substrate of claim 10 wherein said colored pigment is one of an organic and inorganic colored pigment.

12. The method for spraying a decorative coating material on a substrate of claim 1 further comprising:
adding a fire-retardant component to said thixotropic resin mixture.

13. The method for spraying a decorative coating material on a substrate of claim 12 wherein said fire-retardant component is aluminum trihydrate.

14. The method for spraying a decorative coating material on a substrate of claim 1 wherein said substrate is selected from the group consisting of such as concrete, concrete floors, concrete patios, sidewalks, driveways, walls, tile, metal, wood, masonite siding, gypsum, floors, interior/exterior walls, patios, sidewalks, interior floors, and pool decks.

15. A sprayable decorative coating material comprising:
a resin mixture selected from the group consisting of polyureas, and polyurethanes, polycarbonates;
a self-crosslinking acrylic;
a thixotropic thickener; and
a chip material.

16. The sprayable decorative coating material of claim 15 wherein said chip material is selected from the group consisting of acrylic chips and gel coat chips.

17. The sprayable decorative coating material of claim 15 wherein said thixotropic thickener is a material having Newtonian characteristics.

18. The sprayable decorative coating material of claim 15 wherein said thixotropic thickener further comprises:
a wetting agent.

19. The sprayable decorative coating material of claim 15 further comprising a carbodiimide.

20. The sprayable decorative coating material of claim 15 further comprising an aqueous silicone to said thixotropic resin mixture.

21. The sprayable decorative coating material of claim 15 further a colored pigment to said thixotropic resin mixture.

22. The sprayable decorative coating material of claim 21 wherein said colored pigment is one of an organic and inorganic colored pigment.

23. The sprayable decorative coating material of claim 15 further comprising a fire-retardant component to said thixotropic resin mixture.

24. The sprayable decorative coating material of claim 23 wherein said fire-retardant component is aluminum trihydrate.
